(19) United States
(12) Patent Application Publication
(10) Pub. No.: US 2026/0141618 A1
(43) Pub. Date: May 21, 2026

(54) FOUR-DIMENSIONAL SCENE GENERATION FOR AUTONOMOUS DRIVING

(71) Applicant: NVIDIA CORPORATION, Santa Clara, CA (US)

(72) Inventors: Jiageng MAO, Los Angeles, CA (US); Yue WANG, Los Angeles, CA (US); Yuxiao CHEN, Campbell, CA (US); Boris IVANOVIC, Mountain View, CA (US); Marco PAVONE, Stanford, CA (US); Boyi LI, New York, NY (US); Yan WANG, Santa Clara, CA (US); Chaowei XIAO, Seattle, WA (US); Danfei XU, Atlanta, GA (US); Yurong YOU, Ithaca, NY (US)

(21) Appl. No.: 19/301,798

(22) Filed: Aug. 15, 2025

Related U.S. Application Data
(60) Provisional application No. 63/721,343, filed on Nov. 15, 2024.

(51) Int. Cl. G06T 15/20

(52) U.S. Cl. CPC G06T 15/20

(57) ABSTRACT

One embodiment of a method for generating scene representations includes processing a first image using a first trained machine learning model to generate one or more second images, processing the one or more second images using a second trained machine learning model to generate three-dimensional (3D) geometry and camera information, and generating a four-dimensional (4D) scene representation based on the 3D geometry and the camera information.

### CROSS-REFERENCE TO RELATED APPLICATIONS

This application claims benefit of the United States Provisional Patent Application titled “TECHNIQUES FOR FOUR-DIMENSIONAL SCENE GENERATION FOR AUTONOMOUS DRIVING,” filed Nov. 15, 2024, and having Ser. No. 63/721,343. The subject matter of this related application is hereby incorporated herein by reference.

### BACKGROUND

### Field of the Various Embodiments

The various embodiments relate generally to computer science, machine learning and artificial intelligence, and autonomous driving and, more specifically, to four-dimensional scene generation for autonomous driving.

### Description of the Related Art

Driving simulation systems provide digital environments that mimic real-world roads and traffic conditions so that virtual vehicles can be driven, observed, and tested without operating a physical vehicle. In the digital environments, roads, intersections, signs, and obstacles are defined as two- or three-dimensional assets; vehicle motion is computed using physics models; and other traffic participants can be controlled by scripted or artificial intelligence (AI) agents to create various driving scenarios.

One approach for creating driving simulation systems involves reconstructing physical environments as digital environments. For example, a neural network called a neural radiance field (NeRF) could be trained from images of a scene to represent the density and color of the scene at different points in three-dimensional (3D) space. Once trained, the NeRF can be used to render images of a digital environment corresponding to the scene. One drawback of the above approach, however, is that very well-calibrated cameras and accurate alignment across sensors, time, and map coordinates are required to reconstruct physical environments. Such well-calibrated cameras and accurate alignment may not be readily available.

Another approach for creating driving simulation systems involves using a video generation model to generate videos of digital environments for the driving simulations. For example, video diffusion models are one type of model that can be used to generate high-quality videos. One drawback of such an approach, however, is that the generated videos can suffer from geometric consistency issues. For example, video diffusion models oftentimes operate with weak or no explicit 3D scene representations, causing geometry to drift over time. In that regard, video diffusion models only predict pixels of video frames, which may not be aligned with underlying geometries in a scene.

As the foregoing illustrates, what is needed in the art are more effective techniques for generating driving simulations.

### SUMMARY

One embodiment of the present disclosure sets forth a computer-implemented method for generating representations of scenes. The method includes processing a first image using a first trained machine learning model to generate one or more second images. The method further includes processing the one or more second images using a second trained machine learning model to generate three-dimensional (3D) geometry and camera information. In addition, the method includes generating a four-dimensional (4D) scene representation based on the 3D geometry and the camera information.

Other embodiments of the present disclosure include, without limitation, one or more computer-readable media including instructions for performing one or more aspects of the disclosed techniques as well as a computing device for performing one or more aspects of the disclosed techniques.

One technical advantage of the disclosed techniques relative to the prior art is that, with the disclosed techniques, static and dynamic elements in a scene can be accurately modeled from an image to generate a driving simulation. The disclosed techniques are also able to generate accurate modeling without requiring well-calibrated cameras or accurate alignment across sensors, time, and map coordinates, which reduces the complexity of the modeling system and reduces the need for high accuracy sensor data sets. The disclosed techniques also generate geometry-consistent driving videos that are generalizable to diverse driving scenarios. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be found by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer system configured to implement one or more aspects of the various embodiments;

FIG. 2 is a block diagram of a parallel processing unit included in the parallel processing subsystem of FIG. 1, according to various embodiments;

FIG. 3 is a block diagram of a general processing cluster included in the parallel processing unit of FIG. 2, according to various embodiments;

FIG. 4 is a more detailed illustration of the four-dimensional scene generator of FIG. 1, according to various embodiments;

FIG. 5 illustrates exemplar driving videos rendered from four-dimensional (4D) scenes that are generated from different images, according to various embodiments;

FIG. 6 illustrates exemplar driving videos that are generated for different driving trajectories, according to various embodiments;

FIG. 7 illustrates exemplar collision checking using a 4D spatio-temporal scene, according to various embodiments;

FIG. 8 is a flow diagram of method steps for generating a 4D scene, according to various embodiments; and

FIG. 9 is a flow diagram of method steps for rendering images using a 4D scene, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for generating four-dimensional (4D) scenes. In some embodiments, given an image of a scene, a scene generator application processes the image using a video diffusion model to generate a number of reference images. The scene generator further processes the reference images using a multiview stereo model to generate dense three-dimensional (3D) geometry, such as a pixel-aligned 3D point cloud, and camera information associated with the reference images. The scene generator initializes Gaussians based on the dense 3D geometry and camera information. Then, the scene generator trains a self-supervised scoring network to separate the Gaussians into static and dynamic components. The scene generator also clusters the Gaussians and performs majority voting to obtain static and dynamic Gaussians. The scene generator further trains a deformation network to model the dynamic Gaussians as time-dependent Gaussians. In addition, the scene generator combines the static and dynamic Gaussians into a 4D spatio-temporal scene and optimizes parameters of the Gaussians using a photometric loss. Thereafter, given a driving trajectory, the scene generator splats the static and dynamic Gaussians of the 4D spatio-temporal scene into images at different timesteps to generate a driving video. Driving videos that are generated in such a manner can be used to train a machine learning model to control a vehicle for autonomous driving, among other things.

The techniques for generating 4D scenes have many real-world applications. For example, the techniques can be used to generate 4D scenes for rendering images that are used to train machine learning models, such as machine learning models that plan the driving trajectories of autonomous vehicles. As another example, the techniques can be used to generate 4D scenes that are used to check for collisions when autonomous vehicles follow simulated trajectories. As yet another example, the techniques can be used to generate 4D scenes that are used to provide virtual reality environments.

The above examples are not in any way intended to be limiting. As persons skilled in the art will appreciate, as a general matter, the techniques for automatically generating designs of processors described herein can be implemented anywhere that designs of processors are required or useful.

### System Overview

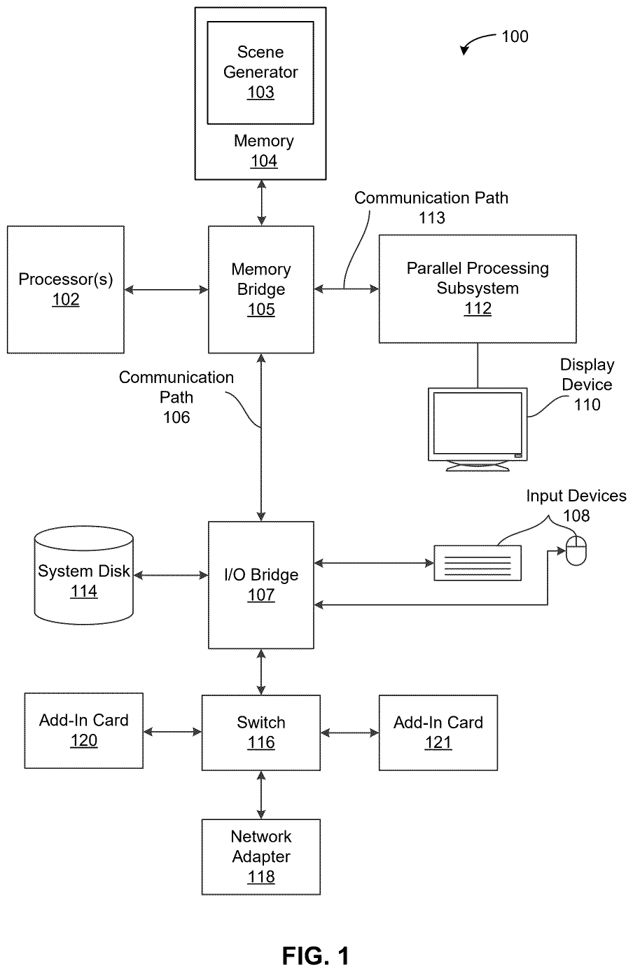

FIG. 1 is a block diagram illustrating a computer system 100 configured to implement one or more aspects of the present embodiments. As persons skilled in the art will appreciate, computer system 100 can be any type of technically feasible computer system, including, without limitation, a server machine, a server platform, a desktop machine, laptop machine, a hand-held/mobile device, or a wearable device. In some embodiments, computer system 100 is a server machine operating in a data center or a cloud computing environment that provides scalable computing resources as a service over a network.

In various embodiments, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as a keyboard or a mouse, and forward the input information to CPU 102 for processing via communication path 106 and memory bridge 105. In some embodiments, computer system 100 may be a server machine in a cloud computing environment. In such embodiments, computer system 100 may not have input devices 108. Instead, computer system 100 may receive equivalent input information by receiving commands in the form of messages transmitted over a network and received via network adapter 118. In one embodiment, switch 116 is configured to provide connections between I/O bridge 107 and other components of computer system 100, such as a network adapter 118 and various add-in cards 120 and 121.

In one embodiment, I/O bridge 107 is coupled to a system disk 114 that may be configured to store content and applications and data for use by CPU 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

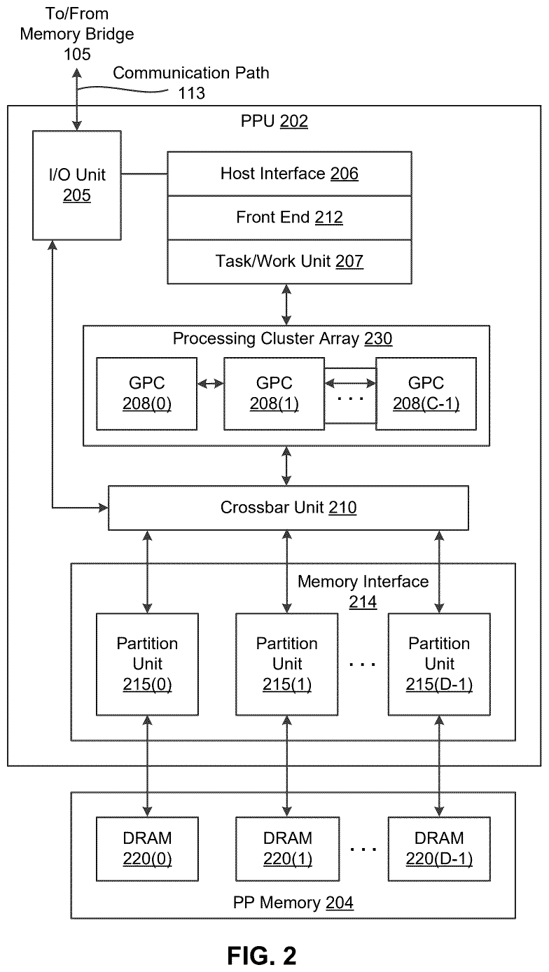

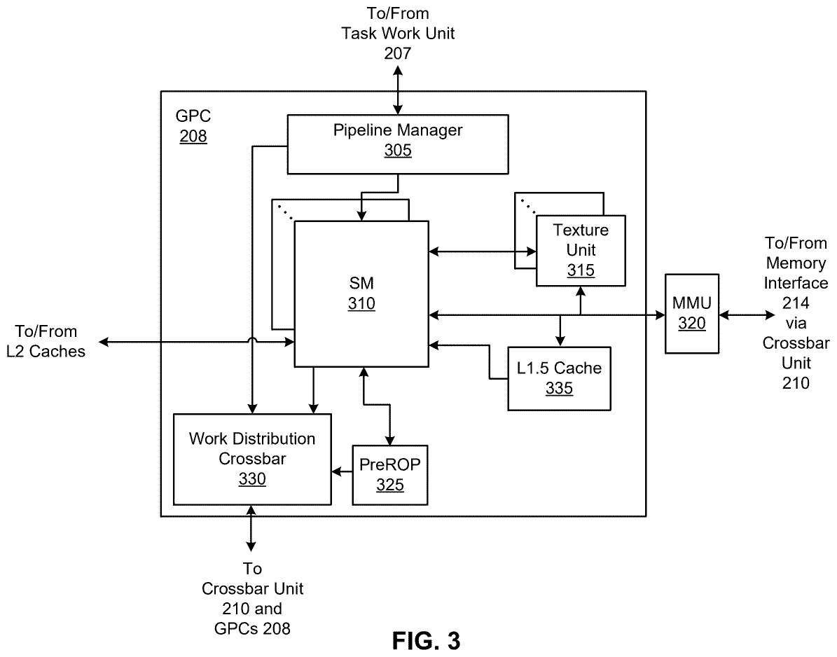

In some embodiments, parallel processing subsystem 112 comprises a graphics subsystem that delivers pixels to an optional display device 110 that may be any conventional cathode ray tube, liquid crystal display, light-emitting diode display, or the like. In such embodiments, parallel processing subsystem 112 incorporates circuitry optimized for graphics and video processing, including, for example, video output circuitry. As described in greater detail below in conjunction with FIGS. 2-3, such circuitry may be incorporated across one or more parallel processing units (PPUs), also referred to herein as parallel processors, included within parallel processing subsystem 112. In other embodiments, parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations.

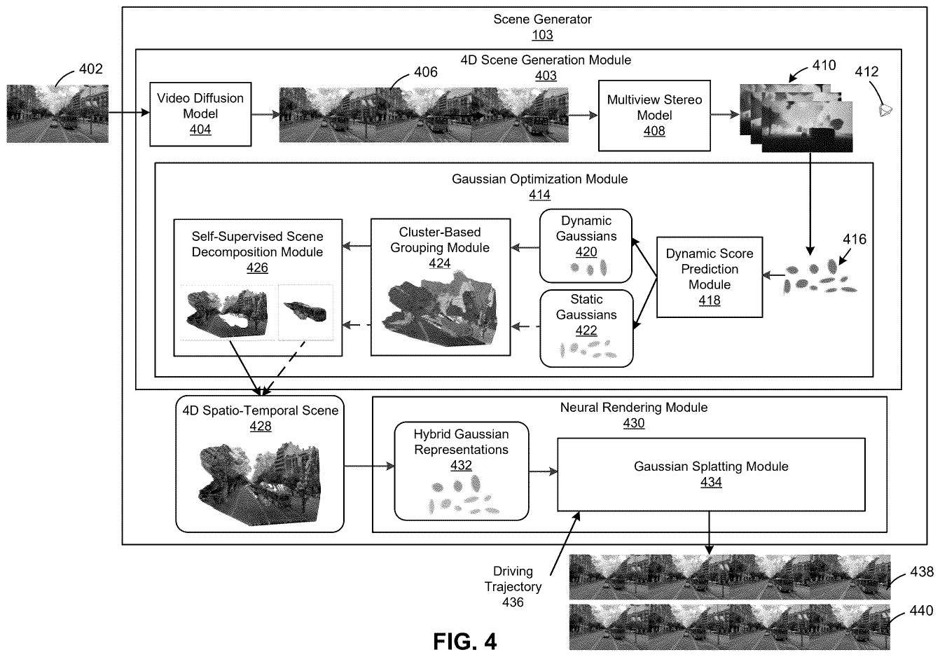

Illustratively, system memory 104 stores a scene generator application 103 (also referred to herein as “scene generator 103”). Scene generator 103 is configured to generate 4D spatio-temporal scenes from images, and the 4D spatio-temporal scenes can be rendered into images, as described in greater detail below in conjunction with FIGS. 4-9. Although described herein primarily with respect to scene generator 103 as a reference example, techniques disclosed herein can also be implemented, either entirely or in part, in other software and/or hardware, such as in parallel processing subsystem 112.

In various embodiments, parallel processing subsystem 112 may be integrated with one or more of the other elements of FIG. 1 to form a single system. For example, parallel processing subsystem 112 may be integrated with CPU 102 and other connection circuitry on a single chip to form a system on chip (SoC).

In one embodiment, CPU 102 is the master processor of computer system 100, controlling and coordinating operations of other system components. In one embodiment, CPU 102 issues commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other embodiments, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 could be eliminated, and network adapter 118 and add-in cards 120, 121 would connect directly to I/O bridge 107. Lastly, in certain embodiments, one or more components shown in FIG. 1 may be implemented as virtualized resources in a virtual computing environment, such as a cloud computing environment. In particular, parallel processing subsystem 112 may be implemented as a virtualized parallel processing subsystem in some embodiments. For example, parallel processing subsystem 112 could be implemented as a virtual graphics processing unit (GPU) that renders graphics on a virtual machine (VM) executing on a server machine whose GPU and other physical resources are shared across multiple VMs.

FIG. 2 is a block diagram of a parallel processing unit (PPU) 202 included in parallel processing subsystem 112 of FIG. 1, according to various embodiments. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a GPU that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to an optional display device 110 for display. In some embodiments, PPU 202 also may be configured for general-purpose processing and compute operations. In some embodiments, computer system 100 may be a server machine in a cloud computing environment. In such embodiments, computer system 100 may not have a display device 110. Instead, computer system 100 may generate equivalent output information by transmitting commands in the form of messages over a network via network adapter 118.

In some embodiments, CPU 102 is the master processor of computer system 100, controlling and coordinating operations of other system components. In one embodiment, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a command queue, also referred to herein as a pushbuffer, to initiate processing of the stream of commands in the data structure. In one embodiment, PPU 202 reads command streams from the command queue and then executes commands asynchronously relative to the operation of CPU 102. In embodiments where multiple pushbuffers are generated, execution priorities may be specified for each pushbuffer by an application program via device driver to control scheduling of the different pushbuffers.

In one embodiment, PPU 202 includes an I/O (input/output) unit 205 that communicates with the rest of computer system 100 via communication path 113 and memory bridge 105. In one embodiment, I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. In one embodiment, host interface 206 reads each command queue and transmits the command stream stored in the command queue to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In one embodiment, front end 212 transmits processing tasks received from host interface 206 to a work distribution unit (not shown) within task/work unit 207. In one embodiment, the work distribution unit receives pointers to processing tasks that are encoded as task metadata (TMD) and stored in memory. The pointers to TMDs are included in a command stream that is stored as a command queue and received by front end unit 212 from host interface 206. Processing tasks that may be encoded as TMDs include indices associated with the data to be processed as well as state parameters and commands that define how the data is to be processed. For example, the state parameters and commands could define the program to be executed on the data. Also, for example, the TMD could specify the number and configuration of the set of CTAs. Generally, each TMD corresponds to one task. The task/work unit 207 receives tasks from front end 212 and ensures that GPCs 208 are configured to a valid state before the processing task specified by each one of the TMDs is initiated. A priority may be specified for each TMD that is used to schedule the execution of the processing task. Processing tasks also may be received from processing cluster array 230. Optionally, the TMD may include a parameter that controls whether the TMD is added to the head or the tail of a list of processing tasks (or to a list of pointers to the processing tasks), thereby providing another level of control over execution priority.

In one embodiment, PPU 202 implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

In one embodiment, memory interface 214 includes a set of D of partition units 215, where D≥1. Each partition unit 215 is coupled to one or more dynamic random access memories (DRAMs) 220 residing within PPM memory 204. In some embodiments, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

In one embodiment, a given GPC 208 may process data to be written to any of the DRAMs 220 within PP memory 204. In one embodiment, crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In some embodiments, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between GPCs 208 and partition units 215.

In one embodiment, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

In one embodiment, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, wearable devices, servers, workstations, game consoles, embedded systems, and the like.

FIG. 3 is a block diagram of a general processing cluster (GPC) 208 included in the parallel processing unit (PPU) 202 of FIG. 2, according to various embodiments. As shown, GPC 208 includes, without limitation, a pipeline manager 305, one or more texture units 315, a preROP unit 325, a work distribution crossbar 330, and an L1.5 cache 335.

In one embodiment, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In one embodiment, operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In various embodiments, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, 50R), bit-shifting, and computation of various algebraic functions (e.g., planar interpolation and trigonometric, exponential, and logarithmic functions, etc.). Advantageously, the same functional execution unit can be configured to perform different operations.

In one embodiment, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within SM 310, in which case some of the execution may be idle during cycles when that thread group is being processed. A thread group may also include more threads than the number of execution units within SM 310, in which case processing may occur over consecutive clock cycles. Because each SM 310 can support up to G thread groups concurrently, it follows that up to G*M thread groups can be executing in GPC 208 at any given time.

Additionally, in one embodiment, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within SM 310, and m is the number of thread groups simultaneously active within SM 310. In some embodiments, a single SM 310 may simultaneously support multiple CTAs, where such CTAs are at the granularity at which work is distributed to SMs 310.

In one embodiment, each SM 310 contains a level one (L1) cache or uses space in a corresponding L1 cache outside of SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, SMs 310 may beneficially share common instructions and data cached in L1.5 cache 335.

In one embodiment, each GPC 208 may have an associated memory management unit (MMU) 320 that is configured to map virtual addresses into physical addresses. In various embodiments, MMU 320 may reside either within GPC 208 or within memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In one embodiment, in graphics and compute applications, GPC 208 may be configured such that each SM 310 is coupled to a texture unit 315 for performing texture mapping operations, such as determining texture sample positions, reading texture data, and filtering texture data.

In one embodiment, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs.

### Four-Dimensional Scene Generation for Autonomous Driving

FIG. 4 is a more detailed illustration of scene generator 103 of FIG. 1, according to various embodiments. As shown, scene generator 103 includes, without limitation, a 4D scene generation module 403 and a neural rendering module 430. 4D scene generation module 403 includes, without limitation, a video diffusion model 404, a multiview stereo model 408, and a Gaussian optimization module 414. Gaussian optimization module 414 includes, without limitation, a dynamic score prediction module 418, a cluster-based grouping module 424, and a self-supervised scene decomposition module 426. Neural rendering module 430 includes, without limitation, a Gaussian splatting module 434.

In operation, scene generator 103 can receive as input an image of a scene, shown as input image 402. Scene generator 103 processes input image 402 using video diffusion model 404, which is a trained machine learning model, to generate a number of reference images 406. Reference images 406 include the frames of a video that are predicted to follow input image 402. Scene generator 103 further processes reference images 406 using multiview stereo model 408, which is a trained machine learning model, to generate dense 3D geometry, shown as a pixel-aligned 3D point cloud 410, and camera information 412 associated with reference images 406. Gaussian optimization module 414 initializes Gaussians 416 based on pixel-aligned 3D point cloud 410 and camera information 412. Then, dynamic score prediction module 418 trains a self-supervised scoring network (not shown) to separate Gaussians 416 into static and dynamic components, shown as static Gaussians 422 and dynamic Gaussians 420. Cluster-based grouping module 424 clusters the Gaussians, including static Gaussians 422 and dynamic Gaussians 420, into different regions and performs majority voting using the clustered Gaussians to help correct erroneously assigned static and dynamic Gaussians, resulting in more correctly assigned static and dynamic Gaussians. Then, self-supervised scene decomposition module 426 trains a deformation network (not shown) to model the dynamic Gaussians as time-dependent Gaussians. In addition, self-supervised scene decomposition module 426 combines the static and dynamic Gaussians into a 4D spatio-temporal scene and optimizes parameters of the Gaussians using a photometric loss, producing a 4D spatio-temporal scene 428. 4D spatio-temporal scene 428 provides the temporal and spatial alignment required for 3D-consistent video generation. In particular, the separation of static and dynamic Gaussians in 4D spatio-temporal scene 428 can improve the quality of synthesized scenes and separates moving vehicles, pedestrians, and other objects from the background, which boosts the utility of 4D spatio-temporal scene 428 in tasks such as perception and planning for self-driving models. Thereafter, given a driving trajectory 436 as input, neural rendering module 430 inputs driving trajectory 436 and hybrid Gaussian representations 432, which include the static and dynamic Gaussians from of 4D spatio-temporal scene 428, into Gaussian splatting module 434, and Gaussian splatting module 434 splats the static and dynamic Gaussians into images at different timesteps based on driving trajectory 436 to generate a driving video. The splatting process helps ensure that each frame in the driving video retains accurate geometry and consistency across time, addressing the typical shortcomings of generative models. Driving videos 438 and 440 for different driving trajectories are shown as examples. Driving videos 438 and 440 can be used to train a machine learning model (not shown) to control a vehicle for autonomous driving, among other things.

More specifically, the problem of 4D scene generation solved by scene generator 103 is: given input controls, e.g., a single image I_{ctrl} or a map with object locations M_{ctrl}, how can a 4D (3D+time) scene be generated to include a set of 3D Gaussians: {

$${G}_{i}^{t}$$

|i=1, . . . , Nₜ, t=1, . . . , T}, where Nₜ is the number of Gaussians at each timestep t, and T is the total timesteps of this 4D scene. Each 3D Gaussian is parameterized by its mean position x∈ [symbol] ³, q quaternion based rotation r∈ [symbol] ⁴ and scaling s∈ [symbol] ³, an opacity value α, and a set of spherical harmonic (SH) coefficients c to represent view-dependent color: G(x,r,s,α,c). The generation process can be formulated as:

$$G = {F}_{gen} ( {X}_{ctrl} ) , {X}_{ctrl} ∈ \{ {I}_{ctrl} , {M}_{ctrl} \} , \qquad ( 1 )$$

where F_{gen} is the 4D scene generation performed by scene generator 103. With a generated 4D scene representation (e.g., 4D spatio-temporal scene 428), given any driving trajectory (e.g., driving trajectory 436) with camera poses Pₜᵣₐⱼ={P^{t}|t=1, . . . , T}, neural rendering module 430 can synthesize a novel driving video V={I^{t}|t=1, . . . , T} (e.g., driving video 438 or 440) by splatting the 3D Gaussians G^{t} at each timestep t into an image I^{t} with camera pose P^{t}:

$${I}^{t} = {F}_{splat} ( {G}^{t} , {P}^{t} ) , \qquad ( 2 )$$

where Fₛₚₗₐₜ is the 3D Gaussian splatting. 4D driving scenes can be generated with diverse controls X_{ctrl}, and the neural rendering function Fₛₚₗₐₜ of the Gaussian splatting module 434 ensures the spatiotemporal consistency of synthesized driving videos.

As described, video diffusion model 404 is a trained machine learning model, such as a neural network, for video generation. Video diffusion model 404 processes input image 402 to generate a number of reference images 406. For example, in some embodiments, video diffusion model 404 can be a stable video diffusion model that is trained on driving videos. In such cases, the stable video diffusion model can condition the generation of reference images 406 on input image 402. Although described herein primarily with respect to video diffusion models as a reference example, any technically feasible video generation models, such as autoregressive generation models, can be used in some embodiments. Video diffusion models are highly effective at modeling the temporal dynamics of visual data, but relying solely on video diffusion models for trajectory-conditioned video generation can lead to 3D inconsistency, as conventional video diffusion models are designed for 2D image generation without considering the underlying 3D structure. In scene generator 103, video diffusion priors output by video diffusion model are used to generate initial visual references (e.g., reference images 406), which are then elevated to the 4D space for scene generation and 3D-consistent video rendering. Specifically, in some embodiments, video diffusion model 404 can be trained on driving data to generate a sequence of reference images {

$${I}_{ref}^{t}$$

|t=1, . . . , T} and extract latent features Z_{ref} from the early layers of video diffusion model 404 to capture valuable visual dynamics for static-dynamic decomposition. The process is formally expressed as:

$${I}_{ref} , {Z}_{ref} = {F}_{VDM} ( {X}_{ctrl} ) , \qquad ( 3 )$$

where F_{VDM} is video diffusion model 404 and X_{ctrl} is the input control. F_{VDM} provides visual references that guide 4D scene generation. Because video diffusion model 404 can generate references (e.g., reference images 406) from in-the-wild driving data, incorporating video diffusion priors improves the generalization of scene generator 103.

Multiview stereo model 408 is a trained machine learning model, such as a neural network, that processes reference images 406 to estimate dense 3D geometry, shown as a pixel-aligned 3D point cloud 410, and camera information 412 associated with reference images 406. The dense 3D geometry can include shapes of different objects in the scene, such as cars, buses, buildings, etc. Lifting generated images I_{ref} into 4D space is quite challenging without camera poses and 3D information. Therefore, in some embodiments, robust estimation of both camera parameters and 3D structure is crucial as a reliable initialization for 4D scene generation. 4D scene generation module 403 employs multiview stereo model 408, which is an end-to-end multiview stereo network in some embodiments, to produce pixel-aligned dense 3D geometry as pixel-aligned 3D point cloud 410, and simultaneously recover camera poses {

$${P}_{ref}^{t}$$

|t=1, . . . , T}, shown as camera information 412. Any technically feasible multiview stereo model 408 can be used in some embodiments. For example, in some embodiments, multiview stereo model 408 can be a feedforward neural network that takes reference images 406 as input and outputs, for each pixel, a corresponding 3D point. In some embodiments, dense, pixel-aligned 3D point clouds can be generated for each image. In some embodiments, 4D scene generation module 403 estimates camera intrinsics using the Weiszfeld algorithm, and 4D scene generation module 403 computes camera extrinsic parameters by globally aligning the point clouds across frames.

Gaussian optimization module 414 initializes Gaussians 416 based on pixel-aligned 3D point cloud 410 and camera information 412. Each Gaussian 416 can include a center and a covariance matrix controlling a shape, color, and opacity. Gaussians 416 can be initialized by optimizing parameters of Gaussians 416, beginning from random parameter values, based on pixel-aligned 3D point cloud 410 and camera information 412. Errors maps are also computed between renderings from Gaussians 416 and input image 402 during the optimization. More specifically, the aggregated point clouds generated by multiview stereo model 408 form a dense scene-level point cloud 410, which Gaussian optimization module 414 uses to initialize 3D Gaussian parameters, yielding a set of Gaussians Gᵢₙᵢₜ, shown as initialized Gaussians 416. In some embodiments, the 3D Gaussians are further enriched with pixel-aligned latent features Z_{ref}. The whole process can be expressed as:

$${G}_{init} , {P}_{ref} = {F}_{MVS} ( {I}_{ref} , {Z}_{ref} ) , \qquad ( 4 )$$

where F_{MVS} is the multiview stereo network. The foregoing approach ensures accurate 3D scene geometry and camera estimation and serves as a robust initialization of 3D Gaussians.

Dynamic score prediction module 418 trains a self-supervised scoring network (not shown) to separate Gaussians 416 into static and dynamic components, shown as static Gaussians 422 and dynamic Gaussians 420. Static Gaussians 422 can correspond to buildings and other static objects. Dynamic Gaussians 420 can correspond to dynamic objects such as cars, buses, etc. In initialized Gaussians 416, Gaussians corresponding to dynamic objects will result in high photometric errors in associated regions of an image rendered using initialized Gaussians 416 when compared to input image 402. Accordingly, the regions with high photometric errors can be used to supervise the training of a scoring network that separates static from dynamic Gaussians. Any technically feasible scoring network, such as a small multilayer perceptron (MLP), can be used in some embodiments. With the initialized 3D Gaussians Gᵢₙᵢₜ, 416, the next step is to model 4D spatio-temporal driving scenes including both static backgrounds and dynamic objects. Some conventional approaches rely on annotated object boxes to track dynamic objects, limiting their generalization to unannotated data like I_{ref}. Other conventional approaches use pure time-dependent Gaussians that change positions and shapes over time, but the 3D inconsistency in generated images often leads to overfitting and introduces fake dynamics, such as visual deformation in static structures when synthesizing novel views. To overcome these issues, dynamic score prediction module 418 generates a novel hybrid Gaussian representation to model static and dynamic components separately.

More specifically, dynamic score prediction module 418 divides the initial Gaussians Gᵢₙᵢₜ into time-independent static Gaussians G_{static} and time-dependent dynamic Gaussians G_{dynamic}, effectively modeling static structures and dynamic objects. Such a separation ensures that static structures remain consistent over time, mitigating fake dynamics while accurately capturing the movement of dynamic objects. A key challenge in hybrid modeling is separating static and dynamic regions without additional annotations. To tackle this, dynamic score prediction module 418 uses image error maps as effective indicators for distinguishing between static and dynamic regions. Specifically, dynamic score prediction module 418 first optimizes the entire scene by assuming all initial Gaussians Gᵢₙᵢₜ are static. Dynamic score prediction module 418 splats the optimized static Gaussians into static images: P

$${I}_{static} : {I}_{static}^{t} = {F}_{splat} ( {G}_{init} , {P}_{ref}^{t} ) . \qquad ( 5 )$$

Next, the error map at each timestep t is computed as:

$${I}_{err}^{t} = \vert {I}_{static}^{t} - {I}_{ref}^{t} \vert . \qquad ( 6 )$$

The pixels in Iₑᵣᵣ with higher rendering errors indicate the regions that static Gaussians struggle to optimize, suggesting that such areas likely correspond to dynamic objects. Therefore, dynamic score prediction module 418 can use Iₑᵣᵣ as supervisory signals for scene decomposition. In particular, dynamic score prediction module 418 trains a network, F_{score}, that takes the initial Gaussians Gᵢₙᵢₜ and their associated latent features Z_{ref} as input, and outputs binary dynamic scores S to classify each Gaussian as static or dynamic:

$$S = {F}_{score} ( {G}_{init} , {Z}_{ref} ) . \qquad ( 7 )$$

These scores are splatted into image planes using the Gaussian splatting function Fₛₚₗₐₜ, and supervised with error maps Iₑᵣᵣ using the binary cross-entropy loss

$${L}_{bce} : {L}_{dec} = {\sum }_{t = 0}^{T} ( {L}_{bce} ( {F}_{splat} ( S , {P}_{ref}^{t} ) , {I}_{err}^{t} ) ) . \qquad ( 8 )$$

Because the splatting function Fₛₚₗₐₜ is differentiable, the scoring network F_{score} can be optimized end-to-end using the image-based decomposition loss L_{dec}. Finally, dynamic score prediction module 418 separates the initial Gaussians Gᵢₙᵢₜ into static Gaussians

$${G}_{static}^{′}$$

and dynamic Gaussians

$${G}_{dyn}^{′}$$

by applying a threshold τ to the predicted dynamic scores S:

$${G}_{dynamic}^{′} = \{ {G}_{init} \vert S > τ \} , {G}_{static}^{′} = \{ {G}_{init} \vert S \leq τ \} . \qquad ( 9 )$$

Notably, the self-supervised technique for generating hybrid Gaussian representations described above does not require annotations or multiple passes, making the self-supervised technique relatively scalable for large-scale driving scenes.

Cluster-based grouping module 424 clusters the Gaussians, including static Gaussians 422 and dynamic Gaussians 420, into different regions and performs majority voting using the clustered Gaussians to help correct erroneously assigned static and dynamic Gaussians, resulting in more correctly assigned static and dynamic Gaussians. Due to the inherent 3D inconsistencies in generated visual references, fake dynamics, such as local deformations in static structures, often appear in I_{ref}, resulting in the incorrect assignment of dynamic Gaussians to static objects and negatively impacting 4D scene modeling and novel view synthesis. To improve the robustness of our scene decomposition, cluster-based grouping module 424 employs a cluster-based grouping strategy, with the key insight being that objects generally move as a whole, i.e., Gaussians in the same object are likely to have the same dynamic attribute. As object annotations are not used, cluster-based grouping module 424 instead performs “spatiotemporal clustering” to group the Gaussians into clusters. If most Gaussians in a cluster are static, meaning that the whole part should be static, cluster-based grouping module 424 assigns static labels to all of the Gaussians in the cluster, even if some were initially classified as dynamic, and vice versa for dynamic clusters. The process can be expressed as:

$${G}_{static} , {G}_{dynamic} = {F}_{group} ( {G}_{static}^{′} , {G}_{dynamic}^{′} ) , \qquad ( 10 )$$

where F_{group} is the proposed grouping strategy. F_{group} helps to rectify incorrect dynamic score predictions, thereby reducing fake dynamics and leading to more accurate and consistent 4D scene modeling.

Self-supervised scene decomposition module 426 trains a deformation network (not shown) to model the dynamic Gaussians as time-dependent Gaussians, and self-supervised scene decomposition module 426 combines the static and dynamic Gaussians into a 4D spatio-temporal scene and optimizes parameters of the Gaussians using a photometric loss, producing 4D spatio-temporal scene 428. The deformation network is a neural network that is trained to make the dynamic Gaussians evolve over time. Scene decomposition enables scene generator 103 to represent static and dynamic components with distinct Gaussians. Static Gaussians G_{static} model elements such as roads and buildings, with parameters G(x,r,s,α,c) that remain constant over time, ensuring accurate rendering of static structures. Dynamic Gaussians G_{dynamic} model objects such as cars and pedestrians, where Gaussian positions and shapes vary over time:

$${G}_{dynamic}^{t} = G ( {x}^{t} , {r}^{t} , {s}^{t} , α , c ) .$$

Self-supervised scene decomposition module 426 learns a deformation network F_{deform} that takes the Gaussian positions x and a timestep t as input and predicts temporal offsets of the Gaussians: (δx,δr,δs):

$$( δ x , δ r , δ s ) = {F}_{deform} ( x , t ) \qquad ( 11 )$$

$$( {x}^{t} , {r}^{t} , {s}^{t} , α , c ) = ( x + δ x , r + δ r , s + δ s , α , c ) . \qquad ( 12 )$$

The time-dependent dynamic Gaussians G_{dynamic} accurately represent dynamic objects in 4D scenes. In addition, self-supervised scene decomposition module 426 combines G_{static} and G_{dynamic} into a 4D spatio-temporal scene and optimizes their parameters by splatting the Gaussians onto images

$${I}_{render}^{t}$$

at each timestep t:

$${I}_{render}^{t} = {F}_{splat} ( \{ {G}_{static} , {G}_{dynamic}^{t} \} , {P}_{ref}^{t} ) . \qquad ( 13 )$$

The rendering loss can be computed as:

$${L}_{render} = {\sum }_{t = 0}^{T} ( {L}_{1} ( {I}_{render}^{t} , {I}_{ref}^{t} ) + {L}_{SSIM} ( {I}_{render}^{t} , {I}_{ref}^{t} ) ) , \qquad ( 14 )$$

where L_{SSIM} is the structural similarity index (SSIM) loss. Self-supervised scene decomposition module 426 jointly optimizes Gaussian parameters and F_{deform} based on the rendering loss L_{render}, leading to robust 4D scene modeling.

Once generated, 4D spatio-temporal scene 428 can be used in any technically feasible manner. More specifically, based on driving trajectory 436, hybrid Gaussian representations 432 from 4D spatio-temporal scene can be splatted by Gaussian splatting module to generate a driving video. The splatting projects hybrid Gaussian representation 432 into image planes of a camera that follows a camera trajectory, with the assumption that the camera is mounted on a vehicle following driving trajectory 436. Example driving videos 438 and 440 for different driving trajectories are shown for illustrative purposes. In addition to being useful for synthesizing novel-view driving videos with high fidelity and 3D consistency, 4D spatio-temporal scene 428 can also be used to generate training data for training a machine learning model to perform autonomous driving tasks (e.g., perception or planning) or generate 4D driving scenes in a controllable and generalizable manner, among other things. Further, in addition to taking images as input, in some embodiments, 3D scenes can be generated from map layouts and object locations according to techniques disclosed herein, and through neural rendering, view-consistent images can be generated.

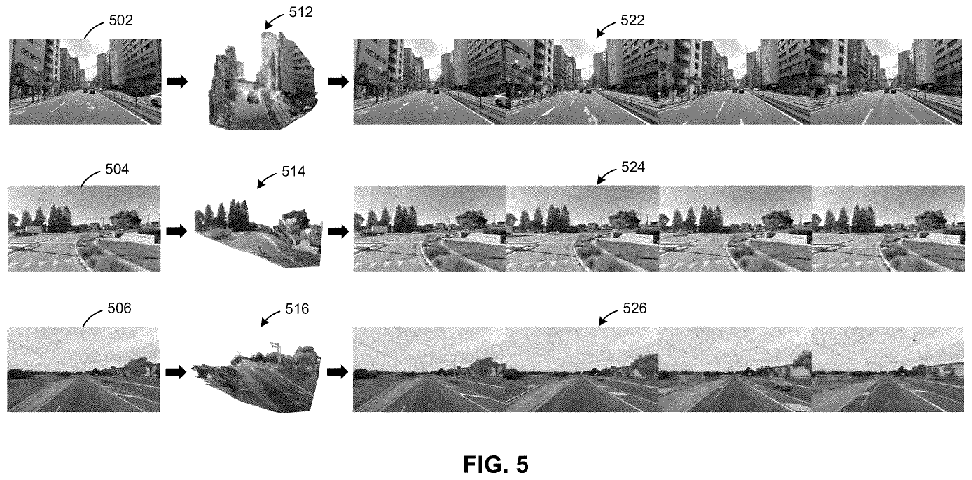

FIG. 5 illustrates exemplar driving videos rendered from 4D scenes that are generated from different images, according to various embodiments. As shown, given images 502, 504, and 506 from diverse geographical locations such as Japan, Australia, and the United States, scene generator 103 can generate 4D spatio-temporal scenes 512, 514, and 516, respectively. In turn, 4D spatio-temporal scenes 512, 514, and 516 can be splatted to generate driving videos 522, 524, and 526, respectively. Illustratively, given an image from anywhere in the world, scene generator 103 can generate a 4D scene and render 3D-consistent driving videos from the 4D scene. Unlike conventional approaches that rely heavily on labeled datasets or precise calibration data, the self-supervised learning performed by scene generator 103 can model 4D driving scenes without the need for exhaustive manual annotations, allowing scene generator 103 to work across various sensory setups and diverse driving scenarios, and eliminating the requirement for specialized data collection.

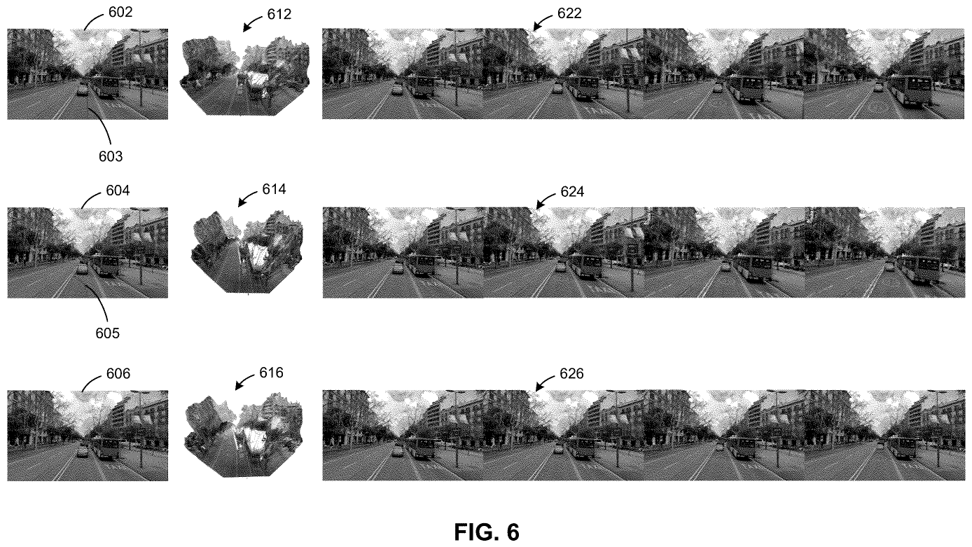

FIG. 6 illustrates exemplar driving videos that are generated for different driving trajectories, according to various embodiments. As shown, given images 602, 604, and 606 that are associated with driving trajectory 603 that represents moving forward, driving trajectory 605 that represents turning left, and stopping, respectively, scene generator 103 can generate 4D spatio-temporal scenes 612, 614, and 616, respectively. Then, scene generator 103 can render, from 4D spatio-temporal scenes 612, 614, and 616, driving videos 622, 624, and 626. Illustratively, scene generator 103 can generate geometry-consistent driving videos with different driving trajectories. Unlike conventional approaches that struggle with geometric consistency when changing viewpoints, scene generator 103 maintains spatial accuracy for static and dynamic elements, helping to ensure realistic and consistent driving video generation. Furthermore, scene generator 103 offers relatively precise trajectory control and 3D consistency by leveraging 4D scene generation and neural rendering.

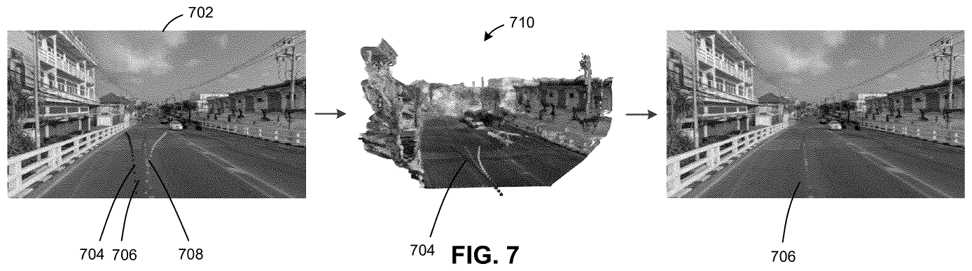

FIG. 7 illustrates exemplar collision checking using a 4D spatio-temporal scene, according to various embodiments. As shown, given an image 702 and sample trajectories 704, 706, and 708, scene generator 103 can generate a 4D spatio-temporal scene 710. Then, scene generator 103 or another application can check for collisions of trajectories 704, 706, and 708 with objects in 4D spatio-temporal scene 710. Then, scene generator 103 or the other application can select trajectory 706 that does not lead to any collisions. Accordingly, scene generator 103 can assist planning in autonomous driving. For example, neural motion planners can be trained on synthetic data, and because scene generator 103 generates 4D scenes, planning trajectories can be checked for collisions with 3D Gaussians in the spatio-temporal domain.

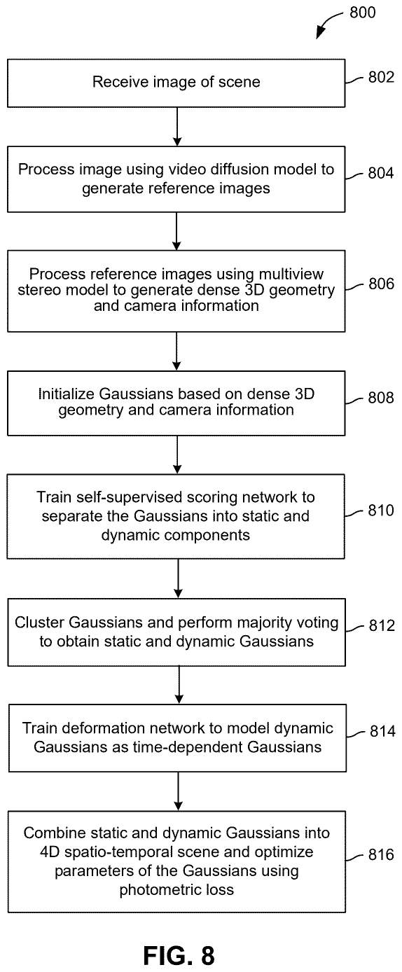

FIG. 8 is a flow diagram of method steps for generating a 4D scene, according to various embodiments. Although the method steps are described in conjunction with the embodiments of FIGS. 1-7, persons skilled in the art will understand that any system configured to perform the method steps, in any order, falls within the scope of the present disclosure.

As shown, a method 800 begins at step 802, where scene generator 103 receives as input an image of a scene. Any suitable image can be received, such as an image captured by a camera mounted on a vehicle.

At step 804, scene generator 103 processes the received image using video diffusion model 404 to generate reference images. The reference images include the frames of a video that are predicted to follow the input image. As described, video diffusion model 404 is a trained machine learning model, such as a neural network, that processes the input image to generate a number of reference images. Video diffusion models are highly effective at modeling the temporal dynamics of visual data, but relying solely on video diffusion models for trajectory-conditioned video generation can lead to 3D inconsistency, as conventional video diffusion models are designed for 2D image generation without considering the underlying 3D structure. In scene generator 103, video diffusion priors output by video diffusion model can be used to generate initial visual references, which can then be elevated to the 4D space for scene generation and 3D-consistent video rendering.

At step 806, scene generator 103 processes the reference images using multiview stereo model 408 to generate dense 3D geometry and camera information. Multiview stereo model 408 is a trained machine learning model, such as a neural network, that processes the reference images to generate dense 3D geometry, such as a pixel-aligned 3D point cloud, and camera information associated with the reference images. As described, in some embodiments, multiview stereo model 408 is an end-to-end multiview stereo network used to produce pixel-aligned dense 3D geometry and simultaneously recover camera poses. In some embodiments, dense, pixel-aligned 3D point clouds can be generated for each image. In some embodiments, 4D scene generation module 403 of scene generator 103 estimates camera intrinsics using the Weiszfeld algorithm, and 4D scene generation module 403 computes camera extrinsic parameters by globally aligning the point clouds across frames.

At step 808, scene generator 103 initializes Gaussians based on the dense 3D geometry and camera information. As described, in some embodiments, the aggregated point clouds generated by multiview stereo model 408 form a dense scene-level point cloud, which Gaussian optimization module 414 of scene generator 103 uses to initialize 3D Gaussian parameters, yielding a set of Gaussians Gᵢₙᵢₜ. In some embodiments, the 3D Gaussians are further enriched with pixel-aligned latent features Z_{ref}. The whole process can be expressed as: Gᵢₙᵢₜ,P_{ref}=F_{MVS}(I_{ref},Z_{ref}), where F_{M}vs is multiview stereo model 408.

At step 810, scene generator 103 trains a self-supervised scoring network to separate the Gaussians into static and dynamic components. As described, in some embodiments, dynamic score prediction module 418 of scene generator 103 generates a hybrid Gaussian representation to model static and dynamic components separately. In such cases, dynamic score prediction module 418 divides the initial Gaussians Gᵢₙᵢₜ into time-independent static Gaussians G_{static} and time-dependent dynamic Gaussians G_{dynamic}, effectively modeling static structures and dynamic objects. Dynamic score prediction module 418 also uses image error maps as effective indicators for distinguishing between static and dynamic regions. Specifically, dynamic score prediction module 418 first optimizes the entire scene by assuming all initial Gaussians Gᵢₙᵢₜ are static. Dynamic score prediction module 418 splats the optimized static Gaussians into static images

$${I}_{static} : {I}_{static}^{t} = {F}_{splat} ( {G}_{i nit} , {P}_{ref}^{t} ) .$$

Next, the error map at each timestep t is computed as:

$${I}_{e r r}^{t} = \vert {I}_{static}^{t} - {I}_{ref}^{t} \vert .$$

The pixels in Iₑᵣᵣ with higher rendering errors indicate the regions that static Gaussians struggle to optimize, suggesting that such areas likely correspond to dynamic objects. Therefore, dynamic score prediction module 418 can use Iₑᵣᵣ as supervisory signals for scene decomposition. In particular, dynamic score prediction module 418 trains a network, F_{score}, that takes the initial Gaussians Gᵢₙᵢₜ and their associated latent features Z_{ref} as input, and outputs binary dynamic scores S to classify each Gaussian as static or dynamic: S=F_{score}(Gᵢₙᵢₜ,Z_{ref}) These scores are splatted into image planes using the Gaussian splatting function Fₛₚₗₐₜ, and supervised with error maps Iₑᵣᵣ using the binary cross-entropy loss L_{bce}:

$${L}_{d e c} = {\sum }_{t = 0}^{T} ( {L}_{bce} ( {F}_{s plat} ( S , {P}_{ref}^{t} ) , {I}_{e r r}^{t} ) ) .$$

Because the splatting function Fₛₚₗₐₜ is differentiable, the scoring network F_{score} can be optimized end-to-end using the image-based decomposition loss L_{dec}. Then, dynamic score prediction module 418 separates the initial Gaussians Gᵢₙᵢₜ into static Gaussians

$${G}_{static}^{′}$$

and dynamic Gaussians

$${G}_{dyn}^{′}$$

by applying a threshold τ to the predicted dynamic scores according to equation (9).

At step 812, scene generator 103 clusters the Gaussians and performs majority voting to obtain static and dynamic Gaussians. As described, in some embodiments, cluster-based grouping module 424 employs a cluster-based grouping strategy that is a “spatiotemporal clustering” to group the Gaussians into clusters. If most Gaussians in a cluster are static, meaning that the whole part should be static, cluster-based grouping module 424 assign static labels to all of the Gaussians in the cluster, even if some were initially classified as dynamic, and vice versa for dynamic clusters, thereby reducing fake dynamics and leading to more accurate and consistent 4D scene modeling.

At step 814, scene generator 103 trains a deformation network to model dynamic Gaussians as time-dependent Gaussians. As described, in some embodiments, self-supervised scene decomposition module 426 of scene generator 103 learns a deformation network F_{deform} that takes the Gaussian positions x and a timestep t as input and predicts temporal offsets of the Gaussians according to equations (11)-(12). The time-dependent dynamic Gaussians G_{dynamic} accurately represent dynamic objects in 4D scenes.

At step 816, scene generator 103 combines the static and dynamic Gaussians into a 4D spatio-temporal scene and optimizes parameters of the Gaussians using a photometric loss. As described, in some embodiments, self-supervised scene decomposition module 426 of scene generator 103 combines the static and dynamic Gaussians G_{static} and G_{dynamic}, respectively, into a 4D spatio-temporal scene and optimizes their parameters by splatting the Gaussians onto images

$${I}_{render}^{t}$$

at each timestep.

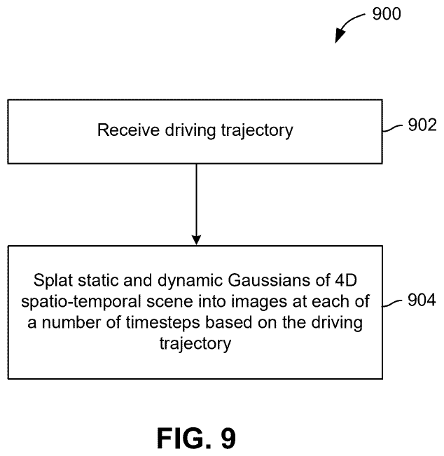

FIG. 9 is a flow diagram of method steps for rendering images using a 4D scene, according to various embodiments. Although the method steps are described in conjunction with the embodiments of FIGS. 1-7, persons skilled in the art will understand that any system configured to perform the method steps, in any order, falls within the scope of the present disclosure.

As shown, a method 900 begins at step 902, where scene generator 103 receives a driving trajectory. The driving trajectory is a path that an autonomous vehicle intends to follow or is currently following through an environment. In some embodiments, the driving trajectory can include a sequence of poses (position and orientation) over time.

At step 904, scene generator 103 splats static and dynamic Gaussians of a 4D spatio-temporal scene into images at each of a number of timesteps based on the driving trajectory. In some embodiments, the 4D spatio-temporal scene can be generated from an input image according to method 800, described above in conjunction with FIG. 8. The rendered images over the timesteps can form a driving video.

In sum, techniques are disclosed for generating 4D scenes, which can be used to train machine learning models for autonomous driving. In some embodiments, given an image of a scene, a scene generator application processes the image using a video diffusion model to generate a number of reference images. The scene generator further processes the reference images using a multiview stereo model to generate dense 3D geometry, such as a pixel-aligned 3D point cloud, and camera information associated with the reference images. The scene generator initializes Gaussians based on the dense 3D geometry and camera information. Then, the scene generator trains a self-supervised scoring network to separate the Gaussians into static and dynamic components. The scene generator also clusters the Gaussians and performs majority voting to obtain static and dynamic Gaussians. The scene generator further trains a deformation network to model the dynamic Gaussians as time-dependent Gaussians. In addition, the scene generator combines the static and dynamic Gaussians into a 4D spatio-temporal scene and optimizes parameters of the Gaussians using a photometric loss. Thereafter, given a driving trajectory, the scene generator splats the static and dynamic Gaussians of the 4D spatio-temporal scene into images at different timesteps to generate a driving video. Driving videos that are generated in such a manner can be used to train a machine learning model to control a vehicle for autonomous driving, among other things.

One technical advantage of the disclosed techniques relative to the prior art is that, with the disclosed techniques, static and dynamic elements in a scene can be accurately modeled from an image to generate a driving simulation. The disclosed techniques are also able to generate accurate modeling without requiring well-calibrated cameras or accurate alignment across sensors, time, and map coordinates, which reduces the complexity of the modeling system and reduces the need for high accuracy sensor data sets. The disclosed techniques also generate geometry-consistent driving videos that are generalizable to diverse driving scenarios. These technical advantages provide one or more technological improvements over prior art approaches.
1. In some embodiments, a computer-implemented method for generating representations of scenes comprises processing a first image using a first trained machine learning model to generate one or more second images, processing the one or more second images using a second trained machine learning model to generate three-dimensional (3D) geometry and camera information, and generating a four-dimensional (4D) scene representation based on the 3D geometry and the camera information.
2. The computer-implemented method of clause 1, wherein generating the 4D scene representation comprises initializing one or more Gaussians based on the 3D geometry and the camera information, separating the one or more Gaussians into one or more static Gaussians and one or more dynamic Gaussians, generating one or more time-dependent Gaussians based on the one or more dynamic Gaussians, and performing one or more iterative optimization operations based on the one or more static Gaussians and the one or more time-dependent Gaussians to generate the 4D scene representation.
3. The computer-implemented method of clauses 1 or 2, wherein separating the one or more Gaussians comprises performing one or more operations to train a third machine learning model to separate the one or more Gaussians into one or more initial static Gaussians and one or more initial dynamic Gaussians, clustering the one or more initial static Gaussian and the one or more initial dynamic Gaussians to generate one or more clusters, and determining the one or more static Gaussians and the one or more dynamic Gaussians based on the one or more clusters.
4. The computer-implemented method of any of clauses 1-3, wherein generating the one or more time-dependent Gaussians comprises performing one or more operations to train a third machine learning model to model the one or more dynamic Gaussians as the one or more time-dependent Gaussians.
5. The computer-implemented method of any of clauses 1-4, wherein the first trained machine learning model comprises a trained video diffusion model.
6. The computer-implemented method of any of clauses 1-5, wherein the second trained machine learning model comprises a trained multiview stereo model.
7. The computer-implemented method of any of clauses 1-6, wherein the 4D scene representation comprises one or more Gaussians associated with one or more stationary objects and one or more time-dependent Gaussians associated with one or more dynamic objects.
8. The computer-implemented method of any of clauses 1-7, further comprising rendering one or more images based on the 4D scene representation and a driving trajectory.
9. The computer-implemented method of any of clauses 1-8, further comprising determining a collision between a driving trajectory and an object in the 4D scene representation.
10. The computer-implemented method of any of clauses 1-9, wherein the one or more second images comprise one or more frames of a video that are subsequent to the first image.
11. In some embodiments, one or more non-transitory computer-readable media that includes instructions that, when executed by one or more processors, cause the one or more processors to perform the steps of processing a first image using a first trained machine learning model to generate one or more second images, processing the one or more second images using a second trained machine learning model to generate three-dimensional (3D) geometry and camera information, and generating a four-dimensional (4D) scene representation based on the 3D geometry and the camera information.
12. The one or more non-transitory computer-readable media of clause 11, wherein generating the 4D scene representation comprises initializing one or more Gaussians based on the 3D geometry and the camera information, separating the one or more Gaussians into one or more static Gaussians and one or more dynamic Gaussians, generating one or more time-dependent Gaussians based on the one or more dynamic Gaussians, and performing one or more iterative optimization operations based on the one or more static Gaussians and the one or more time-dependent Gaussians to generate the 4D scene representation.
13. The one or more non-transitory computer-readable media of clauses 11 or 12, wherein separating the one or more Gaussians comprises performing one or more operations to train a third machine learning model to separate the one or more Gaussians into one or more initial static Gaussians and one or more initial dynamic Gaussians, clustering the one or more initial static Gaussian and the one or more initial dynamic Gaussians to generate one or more clusters, and determining the one or more static Gaussians and the one or more dynamic Gaussians based on the one or more clusters.
14. The one or more non-transitory computer-readable media of any of clauses 11-13, wherein generating the one or more time-dependent Gaussians comprises performing one or more operations to train a third machine learning model to model the one or more dynamic Gaussians as the one or more time-dependent Gaussians.
15. The one or more non-transitory computer-readable media of any of clauses 11-14, wherein the first trained machine learning model comprises a trained video diffusion model, and wherein the second trained machine learning model comprises a trained multiview stereo model.
16. The one or more non-transitory computer-readable media of any of clauses 11-15, wherein the instructions, when executed by the one or more processors, further cause the one or more processors to perform the step of rendering one or more images based on the 4D scene representation and a driving trajectory.
17. The one or more non-transitory computer-readable media of any of clauses 11-16, wherein the instructions, when executed by the one or more processors, further cause the one or more processors to perform the step of determining a collision between a driving trajectory and an object in the 4D scene representation.
18. The one or more non-transitory computer-readable media of any of clauses 11-17, wherein the one or more second images comprise one or more frames of a video that are subsequent to the first image.
19. The one or more non-transitory computer-readable media of any of clauses 11-18, wherein the 3D geometry comprises a point cloud.
20. In some embodiments, a system comprises one or more memories storing instructions, and one or more processors that are coupled to the one or more memories and, when executing the instructions, are configured to process a first image using a first trained machine learning model to generate one or more second images, process the one or more second images using a second trained machine learning model to generate three-dimensional (3D) geometry and camera information, and generate a four-dimensional (4D) scene representation based on the 3D geometry and the camera information.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating representations of scenes, the method comprising:
processing a first image using a first trained machine learning model to generate one or more second images;
processing the one or more second images using a second trained machine learning model to generate three-dimensional (3D) geometry and camera information; and
generating a four-dimensional (4D) scene representation based on the 3D geometry and the camera information.

2. The computer-implemented method of claim 1, wherein generating the 4D scene representation comprises:
initializing one or more Gaussians based on the 3D geometry and the camera information;
separating the one or more Gaussians into one or more static Gaussians and one or more dynamic Gaussians;
generating one or more time-dependent Gaussians based on the one or more dynamic Gaussians; and
performing one or more iterative optimization operations based on the one or more static Gaussians and the one or more time-dependent Gaussians to generate the 4D scene representation.

3. The computer-implemented method of claim 2, wherein separating the one or more Gaussians comprises:
performing one or more operations to train a third machine learning model to separate the one or more Gaussians into one or more initial static Gaussians and one or more initial dynamic Gaussians;
clustering the one or more initial static Gaussian and the one or more initial dynamic Gaussians to generate one or more clusters; and
determining the one or more static Gaussians and the one or more dynamic Gaussians based on the one or more clusters.

4. The computer-implemented method of claim 2, wherein generating the one or more time-dependent Gaussians comprises performing one or more operations to train a third machine learning model to model the one or more dynamic Gaussians as the one or more time-dependent Gaussians.

5. The computer-implemented method of claim 1, wherein the first trained machine learning model comprises a trained video diffusion model.

6. The computer-implemented method of claim 1, wherein the second trained machine learning model comprises a trained multiview stereo model.

7. The computer-implemented method of claim 1, wherein the 4D scene representation comprises one or more Gaussians associated with one or more stationary objects and one or more time-dependent Gaussians associated with one or more dynamic objects.

8. The computer-implemented method of claim 1, further comprising rendering one or more images based on the 4D scene representation and a driving trajectory.

9. The computer-implemented method of claim 1, further comprising determining a collision between a driving trajectory and an object in the 4D scene representation.

10. The computer-implemented method of claim 1, wherein the one or more second images comprise one or more frames of a video that are subsequent to the first image.

11. One or more non-transitory computer-readable media that includes instructions that, when executed by one or more processors, cause the one or more processors to perform the steps of:
processing a first image using a first trained machine learning model to generate one or more second images;
processing the one or more second images using a second trained machine learning model to generate three-dimensional (3D) geometry and camera information; and
generating a four-dimensional (4D) scene representation based on the 3D geometry and the camera information.

12. The one or more non-transitory computer-readable media of claim 11, wherein generating the 4D scene representation comprises:
initializing one or more Gaussians based on the 3D geometry and the camera information;
separating the one or more Gaussians into one or more static Gaussians and one or more dynamic Gaussians;
generating one or more time-dependent Gaussians based on the one or more dynamic Gaussians; and
performing one or more iterative optimization operations based on the one or more static Gaussians and the one or more time-dependent Gaussians to generate the 4D scene representation.

13. The one or more non-transitory computer-readable media of claim 12, wherein separating the one or more Gaussians comprises:
performing one or more operations to train a third machine learning model to separate the one or more Gaussians into one or more initial static Gaussians and one or more initial dynamic Gaussians;
clustering the one or more initial static Gaussian and the one or more initial dynamic Gaussians to generate one or more clusters; and
determining the one or more static Gaussians and the one or more dynamic Gaussians based on the one or more clusters.

14. The one or more non-transitory computer-readable media of claim 12, wherein generating the one or more time-dependent Gaussians comprises performing one or more operations to train a third machine learning model to model the one or more dynamic Gaussians as the one or more time-dependent Gaussians.

15. The one or more non-transitory computer-readable media of claim 11, wherein the first trained machine learning model comprises a trained video diffusion model, and wherein the second trained machine learning model comprises a trained multiview stereo model.

16. The one or more non-transitory computer-readable media of claim 11, wherein the instructions, when executed by the one or more processors, further cause the one or more processors to perform the step of rendering one or more images based on the 4D scene representation and a driving trajectory.

17. The one or more non-transitory computer-readable media of claim 11, wherein the instructions, when executed by the one or more processors, further cause the one or more processors to perform the step of determining a collision between a driving trajectory and an object in the 4D scene representation.

18. The one or more non-transitory computer-readable media of claim 11, wherein the one or more second images comprise one or more frames of a video that are subsequent to the first image.

19. The one or more non-transitory computer-readable media of claim 11, wherein the 3D geometry comprises a point cloud.

20. A system, comprising:
one or more memories storing instructions; and
one or more processors that are coupled to the one or more memories and, when executing the instructions, are configured to:
process a first image using a first trained machine learning model to generate one or more second images,
process the one or more second images using a second trained machine learning model to generate three-dimensional (3D) geometry and camera information, and
generate a four-dimensional (4D) scene representation based on the 3D geometry and the camera information.
